(19) United States
(12) Patent Application Publication
(10) Pub. No.: US 2006/0158870 A1
(43) Pub. Date: Jul. 20, 2006

(54) Illuminated dinnerware

(76) Inventor: Kyu-Woong Lee, Milpitas, CA (US)

Correspondence Address: Kyu-Woong LEE, 199 BALBOA DR., MILPITAS, CA, 95035, US

(21) Appl. No.: 11/035,856

(22) Filed: Jan. 14, 2005

(51) Int. Cl. F21V 33/00

(52) U.S. Cl. 362/109

(57) ABSTRACT

Illuminated dinnerware such as a bowl, plate or mug, where the dinnerware is constructed in layers. A first layer being constructed of fluorescent plastic. A second layer constructed of opaque material. A third transparent layer that is removable and replaceable and whose outer edge extends beyond the edge of the first and second layers. A power supply such as a battery, one or more UV LED's and a switch are wired together to illuminate the fluorescent layer. A preferred embodiment includes additional fluorescent layers can be added to the first layer thereby creating multiple illuminated edges.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of dinnerware and more specifically to illuminated dinnerware.

Dinnerware such as plates, bowls, mugs and utensils made of various materials including ceramic, glass, metal, wood and plastic have been in existence for many years. With the advent of small light sources such as LED's and portable power supplies such as batteries, a number of inventors have experimented with illuminating dinnerware, especially glasses and mugs.

Although the prior art has shown various methods of illuminating dinnerware, they tend to have one or more deficiencies.

These include lack of bright illumination without an excessive power supply. Additionally, there is generally no provision for dish washer cleanability. Additionally, the prior art tends to be rather bulky-in appearance because of the necessity to hide a substantial power supply and illumination source. Additionally, the prior art does not provide for the illumination of multiple peripheral edges at one time. Finally, the prior art does not address the concept of an entire coordinated set of illuminated dinnerware

### BRIEF SUMMARY OF THE INVENTION

The primary object of the invention is to provide dinnerware such as plates bowls and mugs which can be illuminated in a novel manner.

Another object of the invention is to provide tableware utensils such as forks and spoons to be illuminated in a novel manner.

Another object of the invention is to provide illuminated dinnerware and tableware that requires no external power source.

A further object of the invention is to provide illuminated dinnerware and tableware that uses the unique properties of fluorescent plastic to create a glowing edge.

Yet another object of the invention is to provide illuminated dinnerware and tableware that uses ultraviolet LED's to illuminate fluorescent layers.

Still yet another object of the invention is to provide illuminated dinnerware that includes an inner food receiving layer that protects the illuminated portion from debris.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Illuminated dinnerware comprising: dinnerware such as a bowl, plate or mug, said dinnerware constructed in layers, a first layer being constructed of fluorescent plastic, a second layer constructed of opaque material, a third transparent layer that is removable and replaceable and whose outer edge extends beyond the edge of said first and second layers, a power supply such as a battery, one or more UV LED's, a switch, and a housing for said LED's, power supply and switch, said housing attached to the side wall of the outer most layer of said dinnerware.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side section view of the invention.

FIG. 2 is a side section view of a multi fluorescent layer version of the invention.

FIG. 3 is a perspective view of an illuminated bowl.

FIG. 4 is a side section view of an illuminated spoon.

FIG. 5 is a perspective view of an illuminated spoon.

FIG. 6 is a side section view of an illuminated mug.

FIG. 7 is a perspective exploded view of a bowl with detachable light source

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

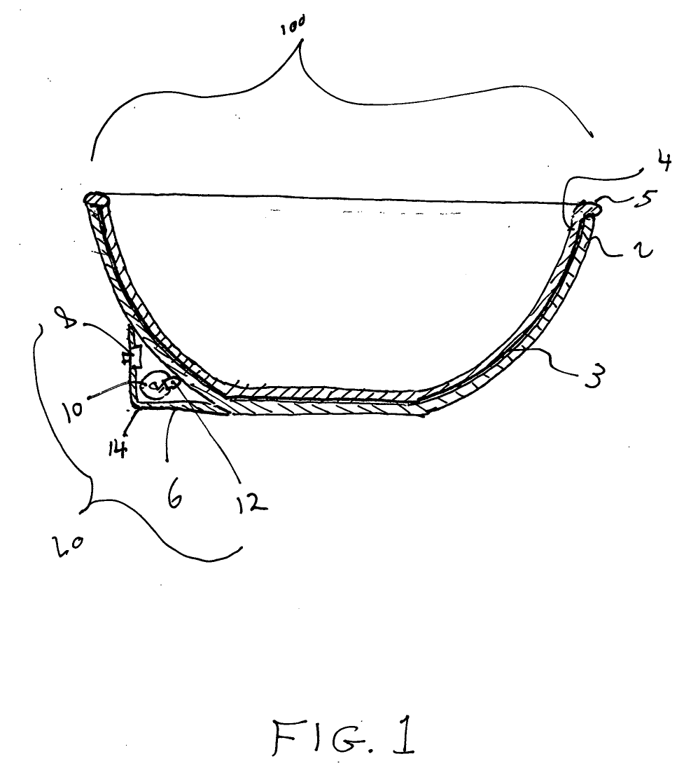

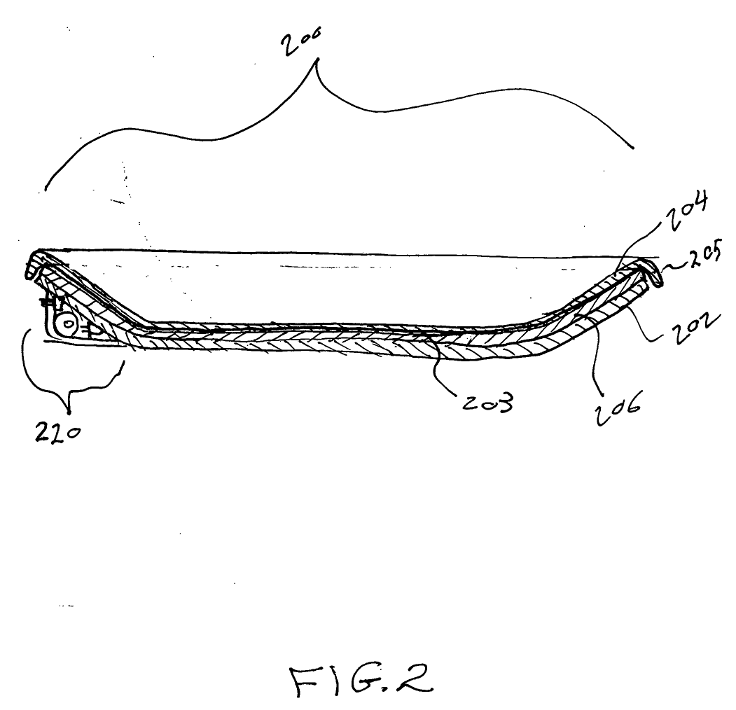

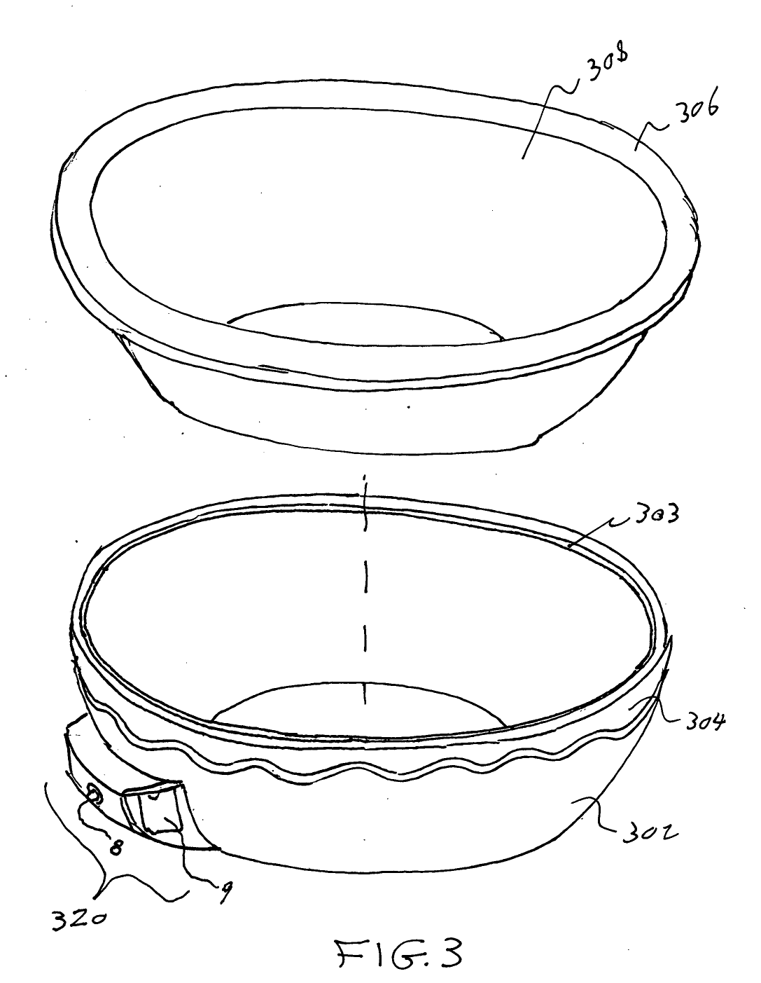

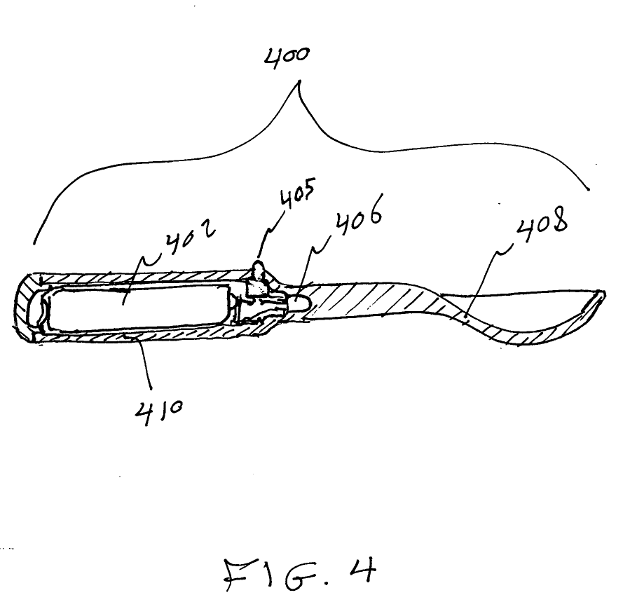

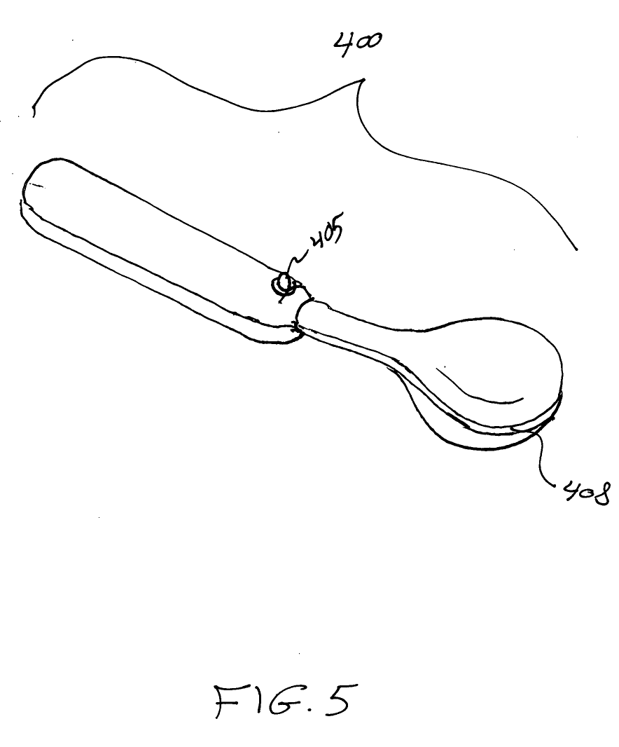

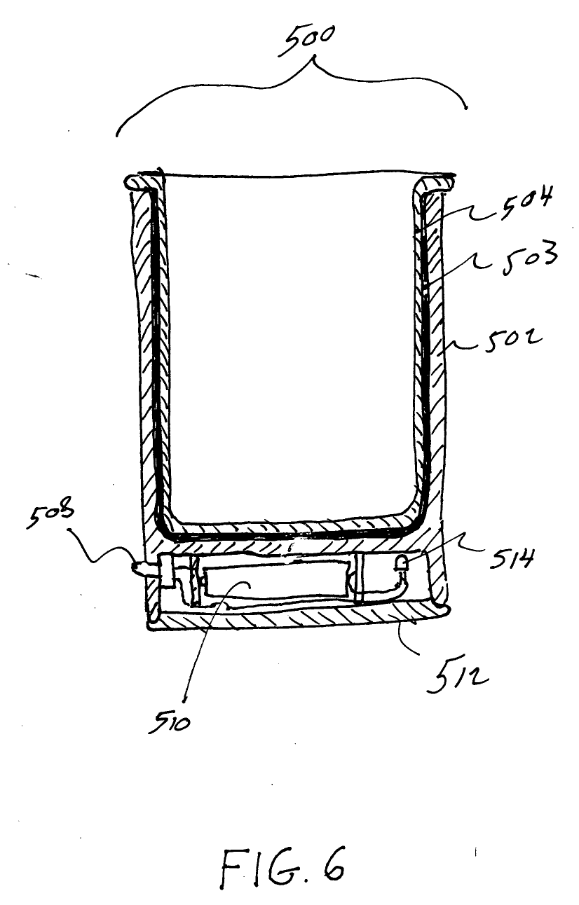

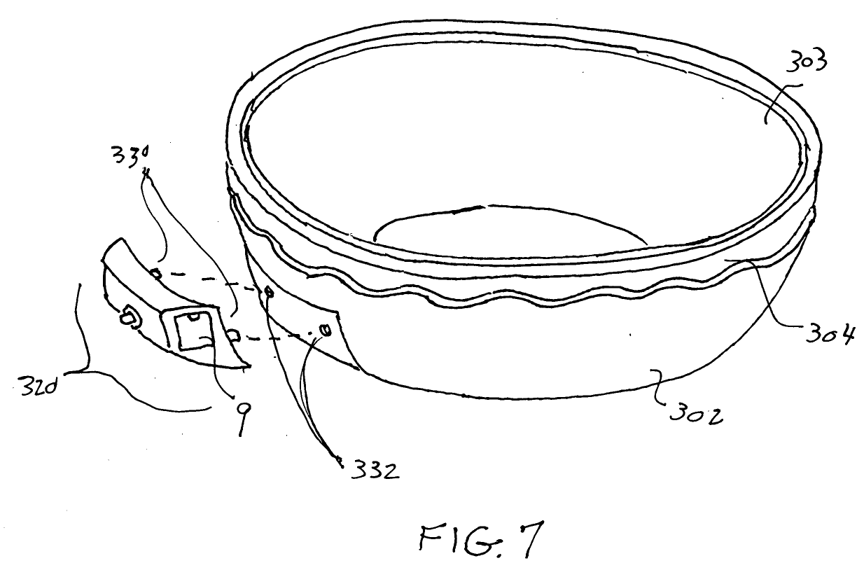

Referring now to FIG. 1 we see a side section view of the invention 100. The representation shown here is a section of a standard shaped bowl as found in current dinnerware designs. The invention is comprised of multi layers. Layer 2 is made of molded plastic such as transparent acrylic that is infused with a fluorescent tint. Layer 3 is an opaque layer that is either applied to the top surface of layer 2 or is a separate molded shape that nests between layer 2 and layer 4. Layer 4 is made of transparent material such as glass or transparent acrylic plastic. Layer 4 includes a flanged edge 5 that protects the top edge of layers 2 and 3. Layer 4 is removable and replaceable for cleaning purposes. Therefore it is not necessary to expose the remainder of the bowl to intense cleaning such as in a dish washing machine. Assembly 20 includes a UV type LED 12, a power supply such as a DC battery 10 and a switch 8 within an enclosure 14. the size enclosure 14 is relatively small in comparison to the entire bowl shape and therefore does not interfere with normal dinnerware use. UV LED 12 is specifically designed to have a maximum illuminating effect on fluorescent plastic as described above. The nature of the illuminating effect is that maximum light transmission is directed to the top perimeter of layer 2 which can then be clearly seen through transparent layer 5. The overall effect is perceived as a relatively standard dinnerware bowl that has a brightly illuminated perimeter edge. FIG. 2 shows a side section view of a dinnerware plate 200. The principles of operation are identical to the ones expressed in FIG. 1 however, in this embodiment I show two layers of fluorescent material 202, 206 which can be two different colors. The opaque layer 203 restricts viewing of the illuminating effect to the double edge at the top perimeter of plate layers 202, 206. The flange 205 of transparent layer 204 extends over both edges of layers 202, 206 thereby protecting them from debris such as food partials. Layer 204 is removable and replaceable for cleaning purposes. Assembly 220 works in the same way as described in FIG. 1. FIG. 3 is a perspective exploded view showing one more embodiment of the present invention. In this embodiment removable transparent bowl layer 308 with flange 306 is clearly shown. In this embodiment two layers of fluorescent material 302, 304 are permanently nested together. The perimeter edge of layer 302 is wavy in shape so that when it glows, a wavy pattern is displayed giving the bowl additional decorative and novel appearance. Layer 303 is an opaque layer so that only the edges of layers 302 and 304 are shown. Assembly 320 is the same as described in FIG. 1. Switch 8 is shown as the on/off switch for turning on or off the enclosed UV LED. Battery door 9 allows the user to remove and replace the power supply battery. FIG. 4 shows a side section view of a dinnerware utensil, in this case a spoon 400. In this embodiment the handle portion 410 is hollow and retains a power supply such as a battery 404, switch 405 and UV type LED 406. Spoon portion 408 is constructed of transparent food grade acrylic infused with fluorescent tint. When the user presses switch 405 it causes the edge of spoon portion 408 to illuminate as shown in FIG. 5. FIG. 6 shows a mug embodiment of the invention 500. The principles of construction are similar to the bowl, plate and spoon described above. Inner liner 504 is transparent and made of glass or transparent plastic and is removable and replaceable for cleaning purposes. Outer layer 502 is made of transparent plastic infused with fluorescent tint. Layer 503 is opaque so that light emanating from UV LED 514 is displayed mainly at the top edge perimeter of layer 502. The switch 508, power supply 510 and LED 514 are housed in a recess in the bottom of the mug as shown. A bottom plate 512 completes the enclosure. It is contemplated that an illuminated plate, bowl, mug and spoon can be marketed together as a coordinated set. The design of the illuminated dinnerware as described above can be styled for elegant adult use or styled for more playful child use. FIG. 7 shows a perspective view of a bowl made in the style as described in FIG. 3 except that light source and power supply assembly 320 is removable and replaceable so that the bowl assembly 302, 303, 304 can be washed in a dish washer without exposing the assembly 320 to water. In this way, it is possible to eliminate the removable transparent bowl 308 from the overall bowl assembly. The housing 320 is attached to a depression in bowl side via posts 330 that frictionally engage with sockets 332. Obviously, this detachable configuration can be applied to other dinnerware items such as plates and mugs and spoons.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Illuminated dinnerware comprising:
dinnerware such as a bowl, plate or mug;
said dinnerware constructed in layers;
a first layer being constructed of fluorescent plastic;
a second layer constructed of opaque material;
a third transparent layer that is removable and replaceable and whose outer edge extends beyond the edge of said first and second layers;
a power supply such as a battery;
one or more UV LED's;
a switch, and
a housing for said LED's, power supply and switch.

2. An alternate embodiment of said Illuminated dinnerware as claimed in claim 1 wherein additional fluorescent layers can be added to said first layer thereby creating multiple illuminated edges.

3. Illuminated dinnerware as claimed in claim 1 wherein said UV LED's are aimed into said fluorescent layer or layers thereby causing the edges of said fluorescent layers to glow brightly.

4. Illuminated dinnerware as claimed in claim 1 wherein said LED's can be turned on or off by said switch.

5. Illuminated dinnerware as claimed in claim 1 wherein said power supply, switch and UV LED are incorporated into a drinking mug.

6. Illuminated dinnerware as claimed in claim I wherein said power supply, switch and UV LED are incorporated in to tableware utensil such as a spoon or fork.

7. An embodiment of said Illuminated dinnerware as claimed in claim 1 wherein said power supply, switch and UV LED assembly housing is removable and replaceable from the main bowl assembly thereby allowing said bowl to be cleaned without exposing said LED assembly to water and thereby eliminating the need for said third transparent layer.
